(19) United States
(12) Patent Application Publication
(10) Pub. No.: US 2026/0302153 A1
(43) Pub. Date: Oct. 1, 2026

(54) LIGHT-EMITTING SEALED BODY

(71) Applicant: HAMAMATSU PHOTONICS K.K., Hamamatsu-shi, Shizuoka (JP)

(72) Inventors: Akio SUZUKI, Shizuoka (JP); Masaru SHIMOMAKI, Shizuoka (JP); Yu MATSUSHIRO, Shizuoka (JP); Kohei SUGITANI, Shizuoka (JP)

(73) Assignee: HAMAMATSU PHOTONICS K.K., Hamamatsu-shi, Shizuoka (JP)

(21) Appl. No.: 19/478,105

(22) PCT Filed: Dec. 21, 2023
(86) PCT No.: PCT/JP2023/045986

§ 371 Date: Oct. 23, 2025

(30) Foreign Application Priority Data
Apr. 27, 2023 (JP) 2023-073560

(51) Int. Cl. H01J 61/30; H01J 61/02; H01J 61/06

(52) U.S. Cl. CPC H01J 61/30; H01J 61/025; H01J 61/06

(57) ABSTRACT

A light-emitting sealed body includes a housing structure housing a gas for generating plasma. The housing structure includes a first window configured to cause first light for maintaining the plasma in a plasma region where the plasma is generated to be incident on the plasma region, a second window configured to emit second light emitted from the plasma from the plasma region, a third window facing the first window with the plasma region interposed therebetween and configured to emit the first light transmitted through the plasma from the plasma region, and a wall having a light shielding property and defining at least a light passage region of the third window.

### TECHNICAL FIELD

The present disclosure relates to a light-emitting sealed body applied to, for example, a laser excitation light source.

### BACKGROUND ART

As a light-emitting sealed body applied to a laser excitation light source, there is known a light-emitting sealed body including a housing that houses a gas for generating plasma. The housing includes a laser beam incidence window for causing a laser beam for maintaining plasma to be incident on a plasma region and a plasma light emission window for emitting plasma light emitted from the plasma from the plasma region, and the plasma light emission window faces the laser beam incidence window with the plasma region interposed therebetween (see, for example, Patent Literature 1).

### CITATION LIST

### Patent Literature

Patent Literature 1: Specification of U.S. Pat. No. 10,008,378

### SUMMARY OF INVENTION

### Technical Problem

In the light-emitting sealed body described above, there is a high possibility that the laser beam transmitted through the plasma is also emitted from the plasma light emission window together with the plasma light. In this case, output light is a mixture of the plasma light and the laser beam, and the quality of the output light deteriorates. In addition, since the laser beam emitted from the plasma light emission window is incident on an optical system for using the plasma light, when the output of the laser beam is increased in order to increase a light emission output, there is a possibility that the laser beam with the increased output adversely influences the optical system by heat or the like. On the other hand, it is conceivable that the laser beam is not emitted to an outside of the light-emitting sealed body in the first place. For example, it is conceivable to dispose a light shielding member or a light absorbing member at a position facing the laser beam incidence window. However, even in this case, when the output of the laser beam is increased, the influence of the heat in the light-emitting sealed body increases, and there is a possibility that the light-emitting sealed body and internal components are damaged.

An object of the present disclosure is to provide a light-emitting sealed body capable of achieving both improvement in quality of output light and improvement in output of output light.

### Solution to Problem

A light-emitting sealed body according to one aspect of the present disclosure is [1] “A light-emitting sealed body including a housing structure housing a gas for generating plasma, in which the housing structure includes a first window configured to cause first light for maintaining the plasma in a plasma region where the plasma is generated to be incident on the plasma region, a second window configured to emit second light emitted from the plasma from the plasma region, a third window facing the first window with the plasma region interposed therebetween and configured to emit the first light transmitted through the plasma from the plasma region, and a wall having a light shielding property and defining at least a light passage region of the third window”.

In the light-emitting sealed body according to the above [1], the housing structure that houses the gas for generating the plasma includes the third window that emits the first light transmitted through the plasma from the plasma region. The third window is a window different from the second window that emits the second light emitted from the plasma from the plasma region, and faces the first window that causes the first light to be incident on the plasma region with the plasma region interposed therebetween. As a result, while the second light is extracted as the output light from the second window, the first light transmitted through the plasma can be extracted from the third window to the outside of the light-emitting sealed body. Accordingly, even though the output of the first light is increased while the mixing of the first light with the output light is suppressed, the influence in the light-emitting sealed body can be suppressed. Thus, in accordance with the light-emitting sealed body according to the above [1], it is possible to achieve both improvement in quality of output light and improvement in output of output light.

The light-emitting sealed body according to one aspect of the present disclosure may be [2] “the light-emitting sealed body according to the above [1], in which the third window also emits the second light emitted from the plasma region to the third window side”. In accordance with the light-emitting sealed body according to the above [2], since the second light emitted from the plasma region to the third window side is also extracted from the third window in addition to the first light transmitted through the plasma, it is possible to suppress the influence of the second light in the light-emitting sealed body, and to achieve both the improvement in the quality of the output light and the improvement in the output of the output light.

The light-emitting sealed body according to one aspect of the present disclosure may be [3] “the light-emitting sealed body according to the above [1] or [2], in which the housing structure includes a housing having the first window and the second window, and an enclosure having the third window and the wall and defining an enclosed space including the plasma region in the housing”. In accordance with the light-emitting sealed body according to the above [3], since the space where the gas convects is narrowed as compared with a case where the housing structure does not have the enclosure, it is possible to reliably suppress the occurrence of the convection in the gas in the space. As a result, since a noise component can be removed from the output light, the quality of the output light can be improved.

The light-emitting sealed body according to one aspect of the present disclosure may be [4] “the light-emitting sealed body according to the above [3], in which the enclosure has a first opening corresponding to the first window and a second opening corresponding to the second window, the first window is positioned on an opposite side to the enclosed space with respect to an open end of the first opening on the enclosed space side, the second window is positioned on an opposite side to the enclosed space with respect to an open end of the second opening on the enclosed space side, and at least one of the first opening and the second opening is narrowed with respect to the enclosed space”. In accordance with the light-emitting sealed body according to the above [4], the occurrence of the convection in the gas can be more reliably suppressed. Thus, the quality of the output light can be improved.

The light-emitting sealed body according to one aspect of the present disclosure may be [5] “the light-emitting sealed body according to the above [3], further including a first electrode having a first distal end facing the plasma region in the housing, a second electrode having a second distal end facing the plasma region in the housing, the second distal end facing the first distal end with the plasma region interposed therebetween, and an insulating first holder holding the first electrode and fixed to the housing, in which the enclosure is an insulating enclosure enclosing the plasma region, the first distal end, and the second distal end in the housing and having a first opening corresponding to the first window and a second opening corresponding to the second window, and at least a part of the enclosure is provided to the first holder”. In accordance with the light-emitting sealed body according to the above [5], at least a part of the enclosure can be formed by using the first holder that holds the first electrode. In addition, since the first distal end of the first electrode and the second distal end of the second electrode are enclosed by the insulating enclosure, even though the enclosed space is narrowed, the plasma can be reliably generated, and the plasma can be stably maintained. Thus, the quality of the output light can be improved.

The light-emitting sealed body according to one aspect of the present disclosure may be [6] “the light-emitting sealed body according to the above [5], further including an insulating second holder holding the second electrode and fixed to the housing, in which the enclosure has a first enclosing portion and a second enclosing portion, the first enclosing portion is provided as the part to the first holder, and the second enclosing portion is provided to the second holder”. In accordance with the light-emitting sealed body according to the above [6], the enclosure can be easily formed by using the first holder holding the first electrode and the second holder holding the second electrode.

The light-emitting sealed body according to one aspect of the present disclosure may be [7] “the light-emitting sealed body according to any one of the above [3] to [6], in which the housing further includes a fourth window facing the third window, and the fourth window emits the first light transmitted through the third window to an outside of the housing”. In accordance with the light-emitting sealed body according to the above [7], of the first light incident on the space where the gas is present, the first light transmitted through the plasma can be emitted to the outside of the housing via the third window of the enclosure and the fourth window of the housing.

The light-emitting sealed body according to one aspect of the present disclosure may be [8] “the light-emitting sealed body according to the above [7], in which each of the first window, the second window, the third window, and the fourth window includes a window member, and a distance between the window member of the third window and the plasma region is smaller than each of a distance between the window member of the first window and the plasma region, a distance between the window member of the second window and the plasma region, and a distance between the window member of the fourth window and the plasma region”. In accordance with the light-emitting sealed body according to the above [8], since the space where the gas convects is narrowed as compared with a case where the enclosure does not have the third window, it is possible to reliably suppress the occurrence of the convection in the gas in the space. As a result, since a noise component can be removed from the output light, the quality of the output light can be improved.

The light-emitting sealed body according to one aspect of the present disclosure may be the above [9] “the light-emitting sealed body according to the above [8], in which a thickness of the window member of the third window is smaller than a thickness of the window member of the fourth window”. In accordance with the light-emitting sealed body according to the above [9], in the window member of the third window, which is closer to the plasma than other window members and has a larger thermal influence by the plasma, it is possible to reduce the influence of thermal expansion and the like by reducing the thickness thereof, and it is possible to suppress breakage of the window member of the third window, a change in a fixed state, and the like. Accordingly, the light-emitting sealed body can be operated stably, and the quality of the output light can be improved.

The light-emitting sealed body according to one aspect of the present disclosure may be [10] “the light-emitting sealed body according to the above [1] or [2], in which the housing structure includes a housing having the first window, the second window, the third window, and the wall, and the housing defines an enclosed space including the plasma region”. In accordance with the light-emitting sealed body according to the above [10], with a simpler configuration, of the first light incident on the space where the gas is present, the first light transmitted through the plasma can be emitted to the outside of the housing via the third window of the housing.

### Advantageous Effects of Invention

In accordance with the present disclosure, it is possible to provide the light-emitting sealed body capable of achieving both the improvement in the quality of the output light and the improvement in the output of the output light.

### BRIEF DESCRIPTION OF DRAWINGS

FIG. 1 is a sectional view of a light-emitting sealed body of a first embodiment.

FIG. 2 is a sectional view of the light-emitting sealed body taken along line II-II illustrated in FIG. 1.

FIG. 3 is a sectional view of the light-emitting sealed body taken along line III-III illustrated in FIG. 1.

FIG. 4 is a sectional view of a light-emitting sealed body of a second embodiment.

FIG. 5 is a sectional view of the light-emitting sealed body taken along line V-V illustrated in FIG. 4.

FIG. 6 is a sectional view of the light-emitting sealed body taken along line VI-VI illustrated in FIG. 4.

FIG. 7 is a sectional view of a light-emitting sealed body of a third embodiment.

FIG. 8 is a sectional view of the light-emitting sealed body taken along line VIII-VIII illustrated in FIG. 7.

FIG. 9 is a sectional view of the light-emitting sealed body taken along line IX-IX illustrated in FIG. 7.

### DESCRIPTION OF EMBODIMENTS

Hereinafter, embodiments of the present disclosure will be described in detail with reference to the drawings. Note that, in the drawings, the same or corresponding parts are denoted by the same reference signs, and redundant description will be omitted.

### First Embodiment

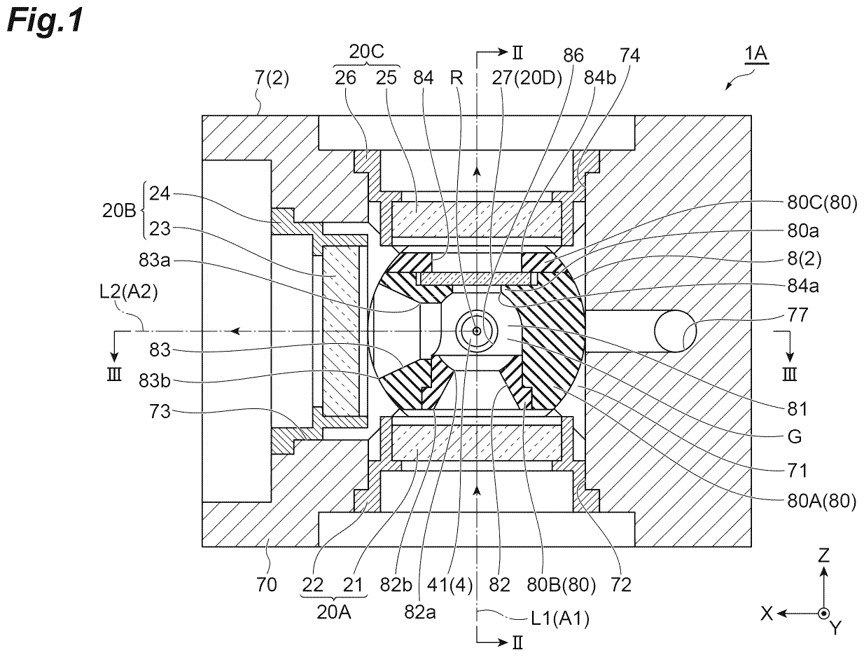

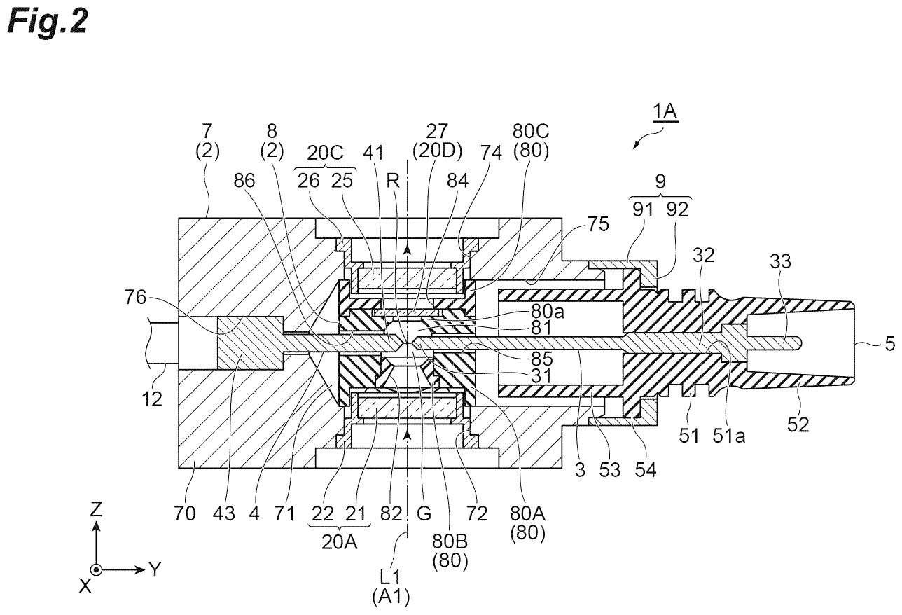

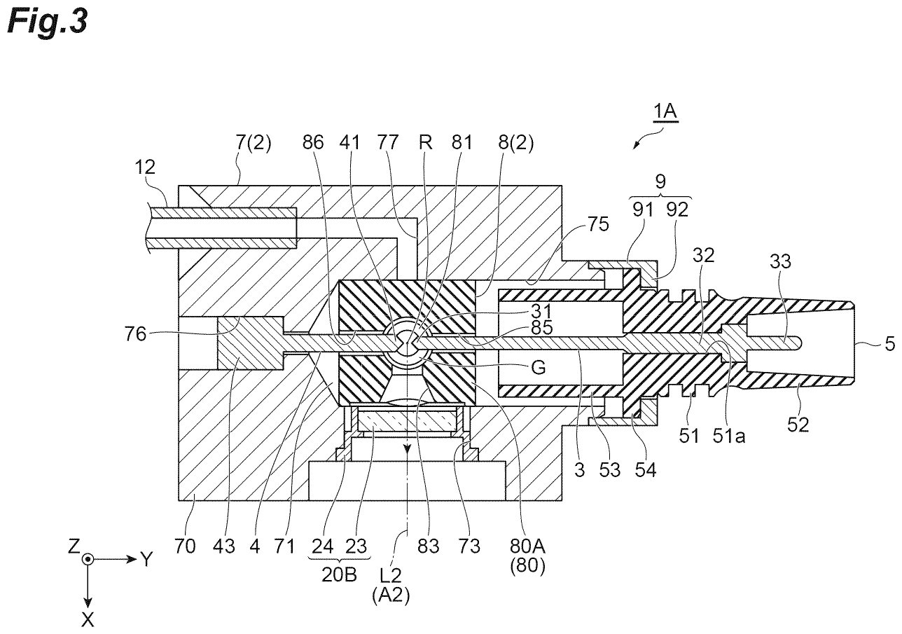

As illustrated in FIGS. 1, 2, and 3, a light-emitting sealed body 1A of a first embodiment includes a housing structure 2, a first electrode 3, a second electrode 4, and a first holder 5. The housing structure 2 includes a housing 7 and an enclosure 8. The housing structure 2 houses a gas G for generating plasma. The gas G is, for example, xenon gas. In the light-emitting sealed body 1A, a laser beam (first light) L1 for maintaining plasma is incident on a plasma region R (region where plasma is generated in the gas G), and plasma light (second light) L2 emitted from the plasma is emitted from the plasma region R. Note that, although the plasma light L2 emitted from the plasma is actually radiationally generated in all directions around the plasma region R, only the plasma light L2 as output light is illustrated for the sake of convenience. A wavelength of the laser beam L1 is, for example, about 800 nm to 1100 nm, and a wavelength of the plasma light L2 is, for example, about 120 nm to 20 μm. The light-emitting sealed body 1A is a device applied to a laser excitation light source.

The housing 7 includes a main body 70, a laser beam incidence window (first window) 20 A, a plasma light emission window (second window) 20B, and a laser beam emission window (fourth window) 20C. In the main body 70, a housing space 71, three window openings 72, 73, and 74, and two electrode openings 75 and 76 are formed. The housing space 71 includes the plasma region R. The window opening 72 is opened to one side in a Z-axis direction from the housing space 71. The window opening 74 is opened to the other side in the Z-axis direction from the housing space 71. The window opening 73 is opened to one side in an X-axis direction (a direction perpendicular to the Z-axis direction) from the housing space 71. The electrode opening 75 is opened to one side in a Y-axis direction (a direction perpendicular to both the Z-axis direction and the X-axis direction) from the housing space 71. The electrode opening 76 is opened to the other side in the Y-axis direction from the housing space 71. A material of the main body 70 is, for example, a metal material such as stainless steel.

The laser beam incidence window 20A airtightly seals the window opening 72. The laser beam incidence window 20A causes the laser beam L1 to be incident on the plasma region R. In the light-emitting sealed body 1A, the laser beam incidence window 20A causes the laser beam L1 to be incident on the plasma region R along an optical axis A1 parallel to the Z-axis direction. In other words, an optical axis of the laser beam L1 is the optical axis A1.

The laser beam incidence window 20A includes a window member 21 and a holding member 22. The window member 21 is formed in a plate shape with the optical axis A1 as a center line and the Z-axis direction as a thickness direction. The window member 21 transmits the laser beam L1. A material of the window member 21 is a light transmissive material having a light transmission property at least for the wavelength of the laser beam L1, and is, for example, sapphire. The holding member 22 is formed in a tubular shape with the optical axis A1 as a center line. The window member 21 is held by the holding member 22 in a state of being disposed inside the holding member 22. A material of the holding member 22 is, for example, a metal material such as Kovar. A side surface of the window member 21 is airtightly joined to an inner surface of the holding member 22 by a joining material such as a metal brazing material. An outer surface of the holding member 22 is airtightly joined to an inner surface of the window opening 72 by, for example, laser welding.

The plasma light emission window 20B airtightly seals the window opening 73. The plasma light emission window 20B is disposed at a position other than a position facing the laser beam incidence window 20A with the plasma region R interposed therebetween. That is, the plasma light emission window 20B does not face the laser beam incidence window 20A with the plasma region R interposed therebetween. The plasma light emission window 20B emits the plasma light L2 from the plasma region R. In the light-emitting sealed body 1A, the plasma light emission window 20B emits the plasma light L2 from the plasma region R along an optical axis A2 parallel to the X-axis direction. In other words, an optical axis of the plasma light L2 is the optical axis A2. Note that, the optical axis A1 and the optical axis A2 intersect at a center of the plasma region R, and intersect vertically in the present embodiment.

The plasma light emission window 20B has a window member 23 and a holding member 24. The window member 23 is formed in a plate shape with the optical axis A2 as a center line and the X-axis direction as a thickness direction. The window member 23 transmits the plasma light L2. A material of the window member 23 is a light transmissive material having a light transmission property at least for the wavelength of the plasma light L2, and is, for example, diamond, sapphire, or magnesium fluoride. The holding member 24 is formed in a tubular shape with the optical axis A2 as the center line. The window member 23 is held by the holding member 24 in a state of being disposed inside the holding member 24. A material of the holding member 24 is, for example, a metal material such as Kovar. A side surface of the window member 23 is airtightly joined to an inner surface of the holding member 24 by a joining material such as a metal brazing material. An outer surface of the holding member 24 is airtightly joined to an inner surface of the window opening 73 by, for example, laser welding.

The laser beam emission window 20C airtightly seals the window opening 74. The laser beam emission window 20C emits the laser beam L1 transmitted through the plasma from the plasma region R. In the present embodiment, in addition to the laser beam L1 transmitted through the plasma, the laser beam emission window 20C also emits the plasma light L2 emitted from the plasma region R to the laser beam emission window 20C side. However, the plasma light L2 is not illustrated for simplification of the drawing. Note that, an optical axis of the plasma light L2 emitted from the laser beam emission window 20C is coaxial with the laser beam L1. In the light-emitting sealed body 1A, the laser beam emission window 20C emits the laser beam L1 from the plasma region R along the optical axis A1. In other words, the emitted light emitted from the laser beam emission window 20C has an optical axis coaxial with the optical axis A1 of the laser beam L1.

The laser beam emission window 20C includes a window member 25 and a holding member 26. The window member 25 is formed in a plate shape with the optical axis A1 as a center line and the Z-axis direction as a thickness direction. The window member 25 transmits the laser beam L1. A material of the window member 25 is a light transmissive material having a light transmission property at least for the wavelength of the laser beam L1, and more preferably a light transmissive material having a light transmission property for the wavelength of the plasma light L2 in addition to the wavelength of the laser beam L1. In the present embodiment, the material of the window member 25 is a material having a light transmission property for both the wavelength of the laser beam L1 and the wavelength of the plasma light L2, and is, for example, sapphire. The holding member 26 is formed in a tubular shape with the optical axis A1 as a center line. The window member 25 is held by the holding member 26 in a state of being disposed inside the holding member 26. A material of the holding member 26 is, for example, a metal material such as Kovar. A side surface of the window member 25 is airtightly joined to an inner surface of the holding member 26 by a joining material such as a metal brazing material. An outer surface of the holding member 26 is airtightly joined to an inner surface of the window opening 74 by, for example, laser welding.

The enclosure 8 is disposed in the housing space 71 of the housing 7. The enclosure 8 includes an insulating main body 80 and an insulating laser beam passage window (third window) 20D. In the main body 80, an enclosed space 81, three light passage openings 82, 83, and 84, and two electrode openings 85 and 86 are formed. The enclosed space 81 includes the plasma region R. The light passage opening 82 is opened to one side in the Z-axis direction from the enclosed space 81. The light passage opening 84 is opened to the other side in the Z-axis direction from the enclosed space 81. The light passage opening 83 is opened to one side in the X-axis direction from the enclosed space 81. The electrode opening 85 is opened to one side in the Y-axis direction from the enclosed space 81. The electrode opening 86 is opened to the other side in the Y-axis direction from the enclosed space 81. Note that, diameters of the electrode openings 85 and 86 are slightly larger than diameters of the first electrode 3 and the second electrode 4. The main body 80 is separated from the first electrode 3 and the second electrode 4 with a slight gap. A length of the gap is ⅕ or less of the diameters of the first electrode 3 and the second electrode 4. Thus, it is possible to suppress the influence of thermal expansion of each member, variations in accuracy and positioning of members, and the like without significantly influencing the trend of gas (occurrence of convection) in the enclosed space 81. The enclosed space 81 is enclosed by a wall of the main body 80, the three light passage openings 82, 83, and 84, and the two electrode openings 85 and 86 in the housing space 71. That is, the enclosure 8 defines the enclosed space 81 in the housing 7 and encloses the plasma region R in the housing 7.

The light passage opening (first opening) 82 corresponds to the laser beam incidence window 20A. That is, as viewed from a direction (the Z-axis direction in the light-emitting sealed body 1A) in which the plasma region R and the laser beam incidence window 20A are arranged, the light passage opening 82 overlaps the laser beam incidence window 20A. In the light-emitting sealed body 1A, a center line of the light passage opening 82 coincides with the center line of the window member 21 of the laser beam incidence window 20A (that is, coincides with the optical axis A1), and the light passage opening 82 is included in the window member 21 of the laser beam incidence window 20A as viewed from the Z-axis direction. The light passage opening 82 is narrowed with respect to the enclosed space 81. That is, as viewed from a direction (the Z-axis direction in the light-emitting sealed body 1A) in which the plasma region R and the light passage opening 82 are arranged, an open end 82a of the light passage opening 82 on the enclosed space 81 side is included in the enclosed space 81. In the light-emitting sealed body 1A, the light passage opening 82 is a tapered opening in which the open end 82a on the enclosed space 81 side is smaller than an open end 82b on an opposite side to the enclosed space 81. The window member 21 of the laser beam incidence window 20A is positioned outside the light passage opening 82.

The light passage opening (second opening) 83 corresponds to the plasma light emission window 20B. That is, as viewed from a direction (the X-axis direction in the light-emitting sealed body 1A) in which the plasma region R and the plasma light emission window 20B are arranged, the light passage opening 83 overlaps the plasma light emission window 20B. In the light-emitting sealed body 1A, a center line of the light passage opening 83 coincides with the center line of the window member 23 of the plasma light emission window 20B (that is, coincides with the optical axis A2), and the light passage opening 83 is included in the window member 23 of the plasma light emission window 20B as viewed from the X-axis direction. The light passage opening 83 is narrowed with respect to the enclosed space 81. That is, as viewed from a direction (the X-axis direction in the light-emitting sealed body 1A) in which the plasma region R and the light passage opening 83 are arranged, an open end 83a of the light passage opening 83 on the enclosed space 81 side is included in the enclosed space 81. In the light-emitting sealed body 1A, the light passage opening 83 is a tapered opening in which the open end 83a on the enclosed space 81 side is smaller than an open end 83b on an opposite side to the enclosed space 81. The window member 23 of the plasma light emission window 20B is positioned outside the light passage opening 83.

The light passage opening 84 corresponds to the laser beam emission window 20C. That is, as viewed from a direction (the Z-axis direction in the light-emitting sealed body 1A) in which the plasma region R and the laser beam emission window 20C are arranged, the light passage opening 84 overlaps the laser beam emission window 20C. In the light-emitting sealed body 1A, a center line of the light passage opening 84 coincides with the center line of the window member 25 of the laser beam emission window 20C (that is, coincides with the optical axis A1), and the light passage opening 84 is included in the window member 25 of the laser beam emission window 20C as viewed from the Z-axis direction. The light passage opening 84 is narrowed with respect to the enclosed space 81. That is, as viewed from a direction (the Z-axis direction in the light-emitting sealed body 1A) in which the plasma region R and the light passage opening 84 are arranged, an open end 84a of the light passage opening 84 on the enclosed space 81 side is included in the enclosed space 81. In the light-emitting sealed body 1A, the light passage opening 84 is a step-shaped opening in which an open end 84a on the enclosed space 81 side is smaller than an open end 84b on an opposite side to the enclosed space 81. The window member 25 of the laser beam emission window 20C is positioned outside the light passage opening 84.

The laser beam passage window 20D is disposed in the light passage opening 84. The laser beam passage window 20D faces the laser beam emission window 20C and faces the laser beam incidence window 20A with the plasma region R interposed therebetween. The laser beam passage window 20D emits the laser beam L1 transmitted through the plasma from the plasma region R. In the present embodiment, in addition to the laser beam L1 transmitted through the plasma, the laser beam passage window 20D also emits the plasma light L2 emitted from the plasma region R to the laser beam passage window 20D side, but the plasma light L2 is not illustrated for simplification of the drawing. Note that, an optical axis of the plasma light L2 emitted from the laser beam passage window 20D is coaxial with the laser beam L1. In the light-emitting sealed body 1A, the laser beam passage window 20D emits the laser beam L1 from the plasma region R along the optical axis A1. In other words, the emitted light emitted from the laser beam passage window 20D has an optical axis coaxial with the optical axis A1 of the laser beam L1. The laser beam passage window 20D has an insulating window member 27. The window member 27 is formed in a plate shape with the optical axis A1 as a center line and the Z-axis direction as a thickness direction. A distance between the window member 27 of the laser beam passage window 20D and the plasma region R is smaller than any of a distance between the window member 21 of the laser beam incidence window 20A and the plasma region R, a distance between the window member 23 of the plasma light emission window 20B and the plasma region R, and a distance between the window member 25 of the laser beam emission window 20C and the plasma region R. A thickness of the window member 27 is smaller than thicknesses of the other window members 21, 23, and 25. The window member 27 transmits the laser beam L1. A material of the window member 27 is a light transmissive material having a light transmission property at least for the wavelength of the laser beam L1, and more preferably a light transmissive material having a light transmission property for the wavelength of the plasma light L2 in addition to the wavelength of the laser beam L1. In the present embodiment, the material of the window member 27 is a material having a light transmission property for both the wavelength of the laser beam L1 and the wavelength of the plasma light L2, and is, for example, sapphire. A light passage region of the laser beam passage window 20D (a region through which the laser beam L1 passes) is defined by a wall 80a of the main body 80 having a light shielding property. In the light-emitting sealed body 1A, a light passage region of the window member 27 is defined by the wall 80a. In other words, as viewed from the direction (the Z-axis direction in the light-emitting sealed body 1A) in which the plasma region R and the light passage opening 84 are arranged, the light passage region of the window member 27 is enclosed by the wall 80a.

Note that, the wall 80a is disposed at a position where it is not irradiated with the laser beam L1 transmitted through the plasma. In other words, the laser beam passage window 20D is provided such that only the light passage region of the window member 27 defined by the wall 80a is irradiated with the laser beam L1 transmitted through the plasma and the laser beam L1 passes only through the light passage region. As a result, it is possible to suppress irradiation of a fixed region between the wall 80a and the window member 27 with the laser beam L1 transmitted through the plasma, and to suppress a change in a fixed state between the wall 80a and the window member 27 due to the influence of heat or the like.

In the light-emitting sealed body 1A, the main body 80 includes a first enclosing member 80A, a second enclosing member 80B, and a third enclosing member 80C. The first enclosing member 80A defines most of the enclosed space 81, the light passage opening 83, a part of the light passage opening 84 on the enclosed space 81 side, and two electrode openings 85 and 86. The second enclosing member 80B defines the light passage opening 82 and a part of the enclosed space 81 on the light passage opening 82 side. The third enclosing member 80C defines most of the light passage opening 84. Each material of the first enclosing member 80A, the second enclosing member 80B, and the third enclosing member 80C is an insulating material having high temperature resistance, and is, for example, ceramic. In particular, in a case where a white ceramic is used, the amount of light extracted from the plasma light emission window 20B can be further increased by reflecting the plasma light L2. The window member 25 is sandwiched between the first enclosing member 80A and the third enclosing member 80C. The first enclosing member 80A, the second enclosing member 80B, and the third enclosing member 80C are held by the housing 7 in a state of being combined with each other together with the window member 25.

The first electrode 3 extends from the outside of the housing 7 into the enclosed space 81 via the electrode opening 75 of the housing 7 and the electrode opening 85 of the enclosure 8. In the light-emitting sealed body 1A, the first electrode 3 is a rod-shaped member extending in the Y-axis direction. A material of the first electrode 3 is, for example, a metal material having a high melting point such as tungsten. A distal end (first distal end) 31 of the first electrode 3 faces the plasma region R in the housing 7. In the light-emitting sealed body 1A, the distal end 31 of the first electrode 3 faces the plasma region R in the enclosed space 81 and is enclosed by the enclosure 8.

The first holder 5 is an insulating member and holds the first electrode 3. A material of the first holder 5 is an insulating material having high temperature resistance, and is, for example, ceramic. In the light-emitting sealed body 1A, the first holder 5 includes a main body 51 and a pair of tubular portions 52 and 53. The tubular portion 52 is positioned on an opposite side to the plasma region R with respect to the main body 51, and the tubular portion 53 is positioned on the plasma region R side with respect to the main body 51. The main body 51 and the tubular portion 52 are disposed outside the electrode opening 75 of the housing 7, and the tubular portion 53 is disposed inside the electrode opening 75 of the housing 7. A through-hole 51a is formed in the main body 51. The through-hole 51a extends in the Y-axis direction and is opened to the inside of each of the tubular portions 52 and 53. An intermediate portion 32 of the first electrode 3 is disposed in the through-hole 51a. A side surface of the intermediate portion 32 is airtightly joined to an inner surface of the through-hole 51a by a joining material such as a metal brazing material. A proximal end 33 of the first electrode 3 is disposed inside the tubular portion 52.

The first holder 5 is fixed to the housing 7. In the light-emitting sealed body 1A, the first holder 5 is fixed to the housing 7 via a tubular connection member 9. The connection member 9 includes a tubular portion 91 and an inward flange 92. The inward flange 92 is provided at an end of the tubular portion 91 on an opposite side to the housing 7. A material of the connection member 9 is, for example, a metal material such as Kovar. The inward flange 92 is airtightly joined to an outward flange 54 provided on the main body 51 of the first holder 5 by a joining material such as a metal brazing material. An end of the tubular portion 91 on the housing 7 side is airtightly joined to the housing 7 by, for example, laser welding.

The second electrode 4 extends from the inside of the electrode opening 76 of the housing 7 into the enclosed space 81 via the electrode opening 86 of the enclosure 8. In the light-emitting sealed body 1A, the second electrode 4 is a rod-shaped member extending in the Y-axis direction. A material of the second electrode 4 is, for example, a metal material having a high melting point such as tungsten. A distal end (second distal end) 41 of the second electrode 4 faces the plasma region R in the housing 7, and faces the distal end 31 of the first electrode 3 with the plasma region R interposed therebetween. In the light-emitting sealed body 1A, the distal end 41 of the second electrode 4 faces the plasma region R in the enclosed space 81 and is enclosed by the enclosure 8. A side surface of a proximal end 43 of the second electrode 4 is airtightly joined to an inner surface of the electrode opening 76 by a joining material such as a metal brazing material.

An encapsulation hole 77 for encapsulating the gas G in the housing space 71 is formed in the main body 70 of the housing 7. An encapsulation tube 12 is connected to the encapsulation hole 77. A material of the encapsulation tube 12 is, for example, a metal material such as copper. An end of the encapsulation tube 12 on an opposite side to the encapsulation hole 77 is sealed. An outer surface of the encapsulation tube 12 is airtightly joined to an inner surface of the encapsulation hole 77 by a joining material such as a metal brazing material.

In the light-emitting sealed body 1A having the above-described configuration, the second electrode 4 is set to a ground potential, and a negative voltage pulse or a positive voltage pulse is applied to the first electrode 3. As a result, arc discharge occurs in the gas G in the enclosed space 81, and plasma is generated between the first electrode 3 and the second electrode 4. At this time, the laser beam L1 is incident on the plasma region R from the laser beam incidence window 20A, and thus, the plasma is maintained in the plasma region R. Then, the plasma light L2 emitted from the plasma is emitted as the output light to the outside from the plasma light emission window 20B.

As described above, in the light-emitting sealed body 1A, the housing structure 2 housing the gas G for generating the plasma includes the laser beam passage window 20D that emits the laser beam L1 transmitted through the plasma from the plasma region R. The laser beam passage window 20D is a window different from the plasma light emission window 20B that emits the plasma light L2 emitted from the plasma from the plasma region R, and faces the laser beam incidence window 20A that causes the laser beam L1 to be incident on the plasma region R with the plasma region R interposed therebetween. As a result, while the plasma light L2 is extracted as the output light from the plasma light emission window 20B, the laser beam L1 transmitted through the plasma can be extracted from the laser beam passage window 20D to an outside of the light-emitting sealed body 1A. Accordingly, even though the output of the laser beam L1 is increased while the mixture of the laser beam L1 with the output light is suppressed, the influence in the light-emitting sealed body 1A can be suppressed. Thus, in accordance with the light-emitting sealed body 1A, it is possible to achieve both the improvement in the quality of the output light and the improvement in the output of the output light.

In the light-emitting sealed body 1A, the laser beam passage window 20D also emits the plasma light L2 emitted from the plasma region R to the laser beam passage window 20D side. As described above, in addition to the laser beam L1 transmitted through the plasma, the plasma light L2 emitted from the plasma region R to the laser beam passage window 20D side is also extracted from the laser beam passage window 20D, and thus, it is possible to suppress the influence of the plasma light L2 in the light-emitting sealed body 1A, and to achieve both the improvement in the quality of the output light and the improvement in the output of the output light.

In the light-emitting sealed body 1A, the housing structure 2 includes the housing 7 having the laser beam incidence window 20A and the plasma light emission window 20B, and the enclosure 8 having the laser beam passage window 20D and the wall 80a and defining the enclosed space 81 including the plasma region R in the housing 7. As a result, since a space where the gas G convects is narrowed as compared with a case where the housing structure 2 does not have the enclosure 8, it is possible to reliably suppress the occurrence of the convection in the gas G in the space. As a result, since a noise component can be removed from the output light, the quality of the output light can be improved.

In the light-emitting sealed body 1A, the laser beam incidence window 20A is positioned on the opposite side to the enclosed space 81 with respect to the open end 82a of the light passage opening 82 on the enclosed space 81 side, the plasma light emission window 20B is positioned on the opposite side to the enclosed space 81 with respect to the open end 83a of the light passage opening 83 on the enclosed space 81 side, and each of the light passage opening 82 and the light passage opening 83 is narrowed with respect to the enclosed space 81. As a result, it is possible to more reliably suppress the occurrence of the convection in the gas G. Thus, the quality of the output light can be improved.

In the light-emitting sealed body 1A, the enclosure 8 is formed by an insulating member. As a result, since the distal end 31 of the first electrode 3 and the distal end 41 of the second electrode 4 are enclosed by the insulating enclosure 8, even though the enclosed space 81 is narrowed, the plasma can be reliably generated, and the plasma can be stably maintained. Thus, the quality of the output light can be improved.

In the light-emitting sealed body 1A, the housing 7 has the laser beam emission window 20C facing the laser beam passage window 20D, and the laser beam emission window 20C emits the laser beam L1 transmitted through the laser beam passage window 20D to an outside of the housing 7. As a result, of the laser beam L1 incident on a space where the gas G is present, the laser beam L1 transmitted through the plasma can be emitted to the outside of the housing 7 via the laser beam passage window 20D of the enclosure 8 and the laser beam emission window 20C of the housing 7. In addition, since the housing 7 can be sealed by the laser beam emission window 20C, the laser beam passage window 20D can have an optimum configuration for functions other than sealing.

In the light-emitting sealed body 1A, the distance between the window member 27 of the laser beam passage window 20D and the plasma region R is smaller than any of the distance between the window member 21 of the laser beam incidence window 20A and the plasma region R, the distance between the window member 23 of the plasma light emission window 20B and the plasma region R, and the distance between the window member 25 of the laser beam emission window 20C and the plasma region R. As a result, since the space where the gas G convects is narrowed as compared with a case where the enclosure 8 does not have the laser beam passage window 20D, it is possible to reliably suppress the occurrence of the convection in the gas G in the space. As a result, since a noise component can be removed from the output light, the quality of the output light can be improved.

In the light-emitting sealed body 1A, the thickness of the window member 27 of the laser beam passage window 20D is smaller than the thickness of the window member 25 of the laser beam emission window 20C. As a result, in the window member 27 of the laser beam passage window 20D, which is closer to the plasma than the other window members 21, 23, and 25 and has a larger thermal influence by the plasma, it is possible to reduce the influence of thermal expansion and the like by reducing the thickness thereof, and it is possible to suppress breakage of the window member 27 of the laser beam passage window 20D, a change in the fixed state, and the like. Accordingly, the light-emitting sealed body 1A can be stably operated, and the quality of the output light can be improved.

### Second Embodiment

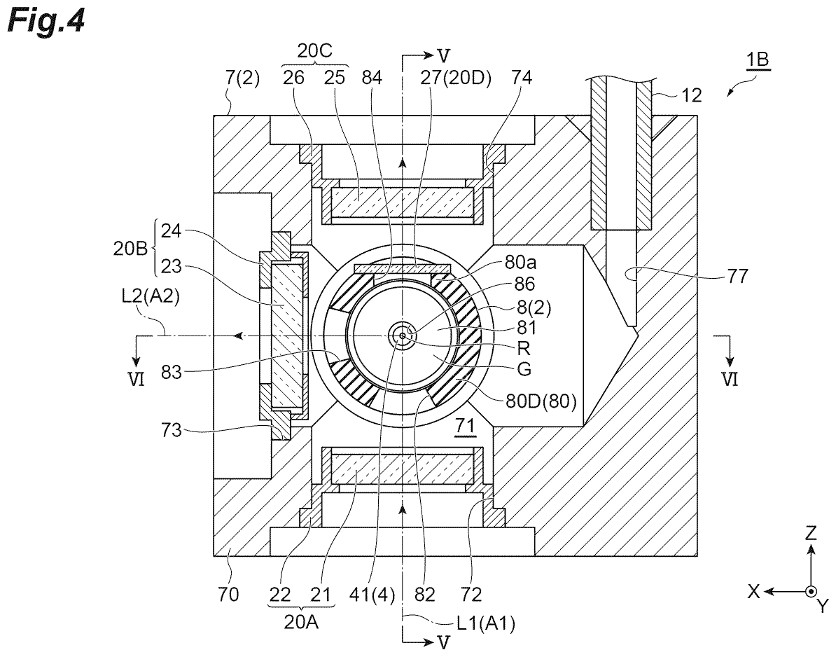

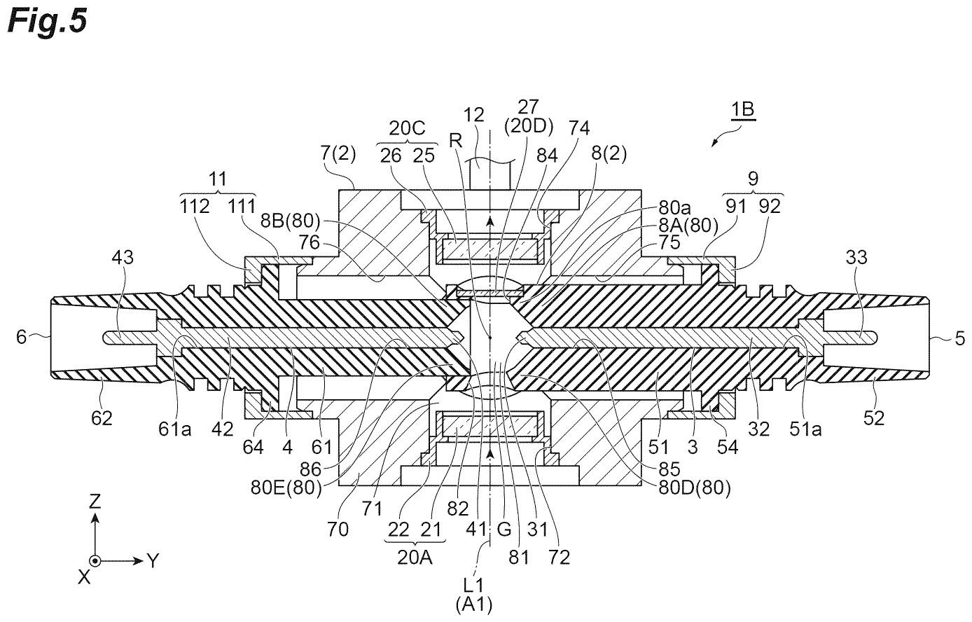

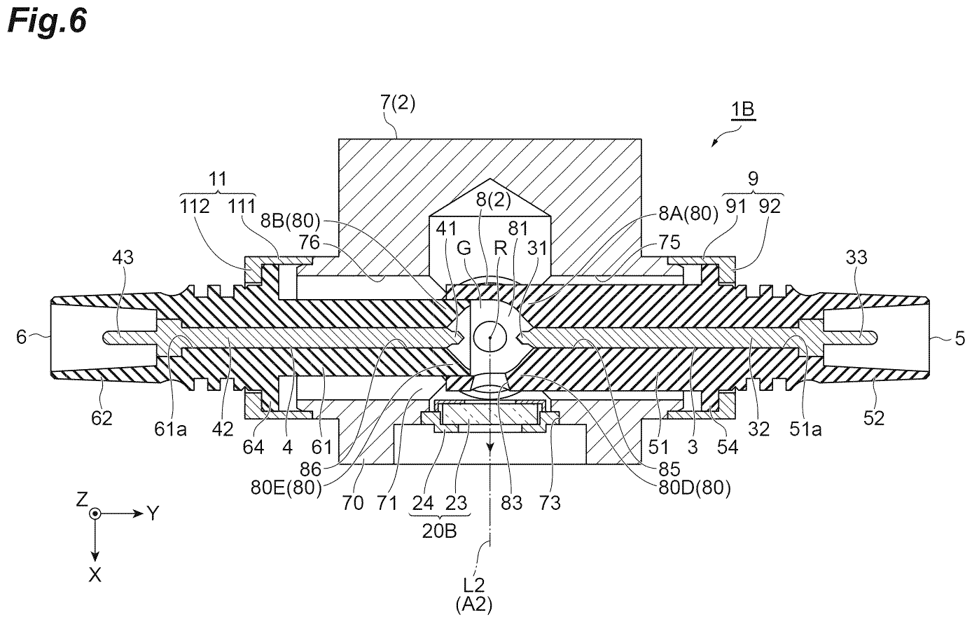

As illustrated in FIGS. 4, 5, and 6, a light-emitting sealed body 1B of a second embodiment is mainly different from the light-emitting sealed body 1A of the first embodiment in that the second electrode 4 is held by a second holder 6, a first enclosing portion 8A of the enclosure 8 is provided on the first holder 5, and a second enclosing portion 8B of the enclosure 8 is provided on the second holder 6. Hereinafter, the light-emitting sealed body 1B of the second embodiment will be described focusing on differences from the light-emitting sealed body 1A of the first embodiment.

As illustrated in FIGS. 4, 5, and 6, the first electrode 3 extends from the outside of the housing 7 into the enclosed space 81 via the electrode opening 75 of the housing 7. The second electrode 4 extends from the outside of the housing 7 into the enclosed space 81 via the electrode opening 76 of the housing 7. In the light-emitting sealed body 1B, each of the first electrode 3 and the second electrode 4 is a rod-shaped member extending in the Y-axis direction.

The first holder 5 is an insulating member and holds the first electrode 3. A material of the first holder 5 is an insulating material having high temperature resistance, and is, for example, ceramic. In the light-emitting sealed body 1B, the first holder 5 has the main body 51 and the tubular portion 52. The tubular portion 52 is positioned on the opposite side to the plasma region R with respect to the main body 51, and is disposed outside the electrode opening 75 of the housing 7. The main body 51 extends from the outside of the housing 7 into the electrode opening 75. The through-hole 51a is formed in the main body 51. The through-hole 51a extends in the Y-axis direction and is opened to the inside of the enclosed space 81 and the tubular portion 52. The intermediate portion 32 of the first electrode 3 is disposed in the through-hole 51a. The side surface of the intermediate portion 32 is airtightly joined to the inner surface of the through-hole 51a by a joining material such as a metal brazing material. The proximal end 33 of the first electrode 3 is disposed inside the tubular portion 52.

The first holder 5 is fixed to the housing 7. In the light-emitting sealed body 1B, the first holder 5 is fixed to the housing 7 via the tubular connection member 9. The connection member 9 includes the tubular portion 91 and the inward flange 92. The inward flange 92 is provided at the end of the tubular portion 91 on the opposite side to the housing 7. The material of the connection member 9 is, for example, a metal material such as Kovar. The inward flange 92 is airtightly joined to the outward flange 54 provided on the main body 51 of the first holder 5 by a joining material such as a metal brazing material. The end of the tubular portion 91 on the housing 7 side is airtightly joined to the housing 7 by, for example, laser welding.

The second holder 6 is an insulating member and holds the second electrode 4. A material of the second holder 6 is an insulating material having high temperature resistance, and is, for example, ceramic. In the light-emitting sealed body 1B, the second holder 6 has a main body 61 and a tubular portion 62. The tubular portion 62 is positioned on an opposite side to the plasma region R with respect to the main body 61, and is disposed outside the electrode opening 76 of the housing 7. The main body 61 extends from the outside of the housing 7 into the electrode opening 76. A through-hole 61a is formed in the main body 61. The through-hole 61a extends in the Y-axis direction and is opened to the inside of the enclosed space 81 and the tubular portion 62. An intermediate portion 42 of the second electrode 4 is disposed in the through-hole 61a. A side surface of the intermediate portion 42 is airtightly joined to an inner surface of the through-hole 61a by a joining material such as a metal brazing material. The proximal end 43 of the second electrode 4 is disposed inside the tubular portion 62.

The second holder 6 is fixed to the housing 7. In the light-emitting sealed body 1B, the second holder 6 is fixed to the housing 7 via a tubular connection member 11. The connection member 11 includes a tubular portion 111 and an inward flange 112. The inward flange 112 is provided at an end of the tubular portion 111 on an opposite side to the housing 7. A material of the connection member 11 is, for example, a metal material such as Kovar. The inward flange 112 is airtightly joined to an outward flange 64 provided on the main body 61 of the second holder 6 by a joining material such as a metal brazing material. An end of the tubular portion 111 on the housing 7 side is airtightly joined to the housing 7 by, for example, laser welding.

The first enclosing portion 8A of the enclosure 8 includes a first portion 80D of the main body 80 and the laser beam passage window 20D. The first portion 80D is a portion of the main body 80 that defines most of the enclosed space 81, the three light passage openings 82, 83, and 84, and the electrode opening 85. A material of the first portion 80D is an insulating material having high temperature resistance, and is, for example, ceramic. The first portion 80D is formed integrally with the first holder 5 in a state where the electrode opening 85 communicates with the through-hole 51a. That is, the first enclosing portion 8A is provided on the first holder 5.

The second enclosing portion 8B of the enclosure 8 has a second portion 80E of the main body 80. The second portion 80E is a portion of the main body 80 that defines a part of the enclosed space 81 on the electrode opening 86 side and the electrode opening 86. A material of the second portion 80E is an insulating material having high temperature resistance, and is, for example, ceramic. The second portion 80E is formed integrally with the second holder 6 in a state where the electrode opening 86 communicates with the through-hole 61a. That is, the second enclosing portion 8B of the enclosure 8 is provided on the second holder 6.

As described above, in the light-emitting sealed body 1B, the first enclosing portion 8A of the enclosure 8 is provided to the insulating first holder 5 that holds the first electrode 3, and the second enclosing portion 8B of the enclosure 8 is provided to the insulating second holder 6 that holds the second electrode 4. As a result, the enclosure 8 can be easily formed by using the first holder 5 that holds the first electrode 3 and the second holder 6 that holds the second electrode 4. In addition, since the distal end 31 of the first electrode 3 and the distal end 41 of the second electrode 4 are enclosed by the insulating enclosure 8, even though the enclosed space 81 is narrowed, the plasma can be reliably generated, and the plasma can be stably maintained. Thus, the quality of the output light can be improved.

### Third Embodiment

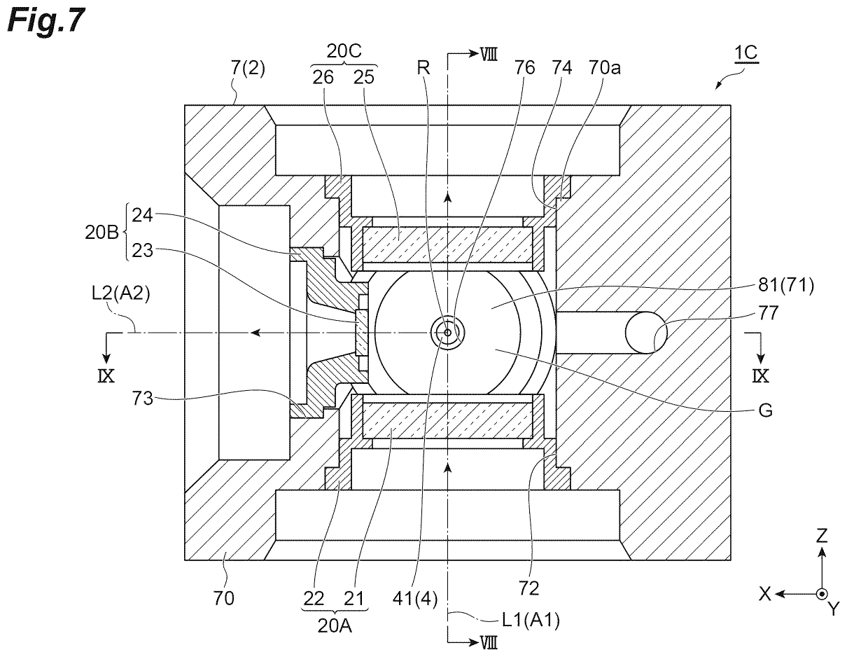

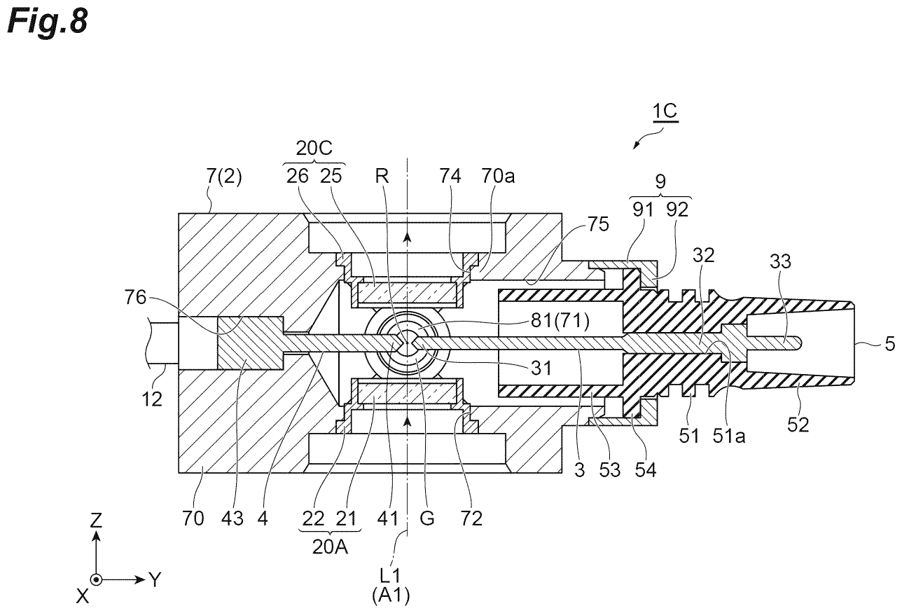

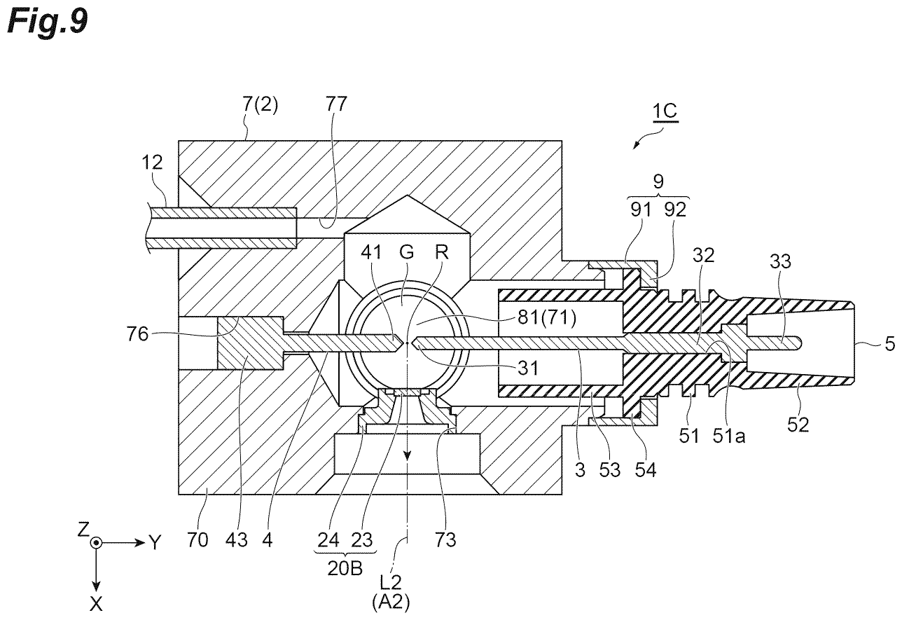

As illustrated in FIGS. 7, 8, and 9, a light-emitting sealed body 1C of a third embodiment is mainly different from the light-emitting sealed body 1A of the first embodiment in that the enclosure 8 is not disposed in the housing space 71 of the housing 7. In the light-emitting sealed body 1C, the housing structure 2 is constituted by the housing 7 having the laser beam incidence window 20A, the plasma light emission window 20B, and the laser beam emission window (third window) 20C, and the enclosed space 81 including the plasma region R is defined by the housing 7. In the light-emitting sealed body 1C, the light passage region of the laser beam emission window 20C is defined by a wall 70a of the main body 70 having a light shielding property.

As described above, in the light-emitting sealed body 1C, the housing structure 2 includes the housing 7 having the laser beam incidence window 20A, the plasma light emission window 20B, the laser beam emission window 20C, and the wall 70a, and the housing 7 defines the enclosed space 81 including the plasma region R. As a result, with a simpler configuration, of the laser beam L1 incident on the space where the gas G is present, the laser beam L1 transmitted through the plasma can be emitted to the outside of the housing 7 via the laser beam emission window 20C of the housing 7.

### Modifications

The present disclosure is not limited to the above embodiments. For example, in the light-emitting sealed body 1A of the first embodiment and the light-emitting sealed body 1B of the second embodiment, the window member 21 of the laser beam incidence window 20A is positioned outside the light passage opening 82, but a part of the window member 21 may be positioned inside the light passage opening 82. The laser beam incidence window 20A may be positioned on the opposite side to the enclosed space 81 with respect to the open end 82a of the light passage opening 82 on the enclosed space 81 side.

In the light-emitting sealed body 1A of the first embodiment and the light-emitting sealed body 1B of the second embodiment, the window member 23 of the plasma light emission window 20B is positioned outside the light passage opening 83, but a part of the window member 23 may be positioned inside the light passage opening 83. The plasma light emission window 20B may be positioned on the opposite side to the enclosed space 81 with respect to the open end 83a of the light passage opening 83 on the enclosed space 81 side.

In the light-emitting sealed body 1A of the first embodiment and the light-emitting sealed body 1B of the second embodiment, at least one of the light passage opening 82 and the light passage opening 83 may be narrowed with respect to the enclosed space 81 in the enclosure 8. In this case, the occurrence of the convection in the gas G can also be reliably suppressed.

In the light-emitting sealed body 1B of the second exemplary embodiment, at least a part of the enclosure 8 may be provided to the insulating first holder 5 that holds the first electrode 3. In this case, at least a part of the enclosure 8 can also be formed by using the first holder 5 that holds the first electrode 3. As an example, the entire enclosure 8 may be provided to the insulating first holder 5 that holds the first electrode 3.

The light-emitting sealed body 1A of the first embodiment, the light-emitting sealed body 1B of the second embodiment, and the light-emitting sealed body 1C of the third embodiment may not include the first electrode 3 and the second electrode 4. In this case, the plasma can also be generated by irradiating the gas G with the laser beam L1. In the light-emitting sealed body 1A of the first embodiment, the light-emitting sealed body 1B of the second embodiment, and the light-emitting sealed body 1C of the third embodiment, a plurality of plasma light emission windows 20B may be provided to the housing 7, and the housing structure 2 may be constituted such that the plasma light L2 is emitted from each of the plasma light emission windows 20B.

### REFERENCE SIGNS LIST

1A, 1B, 1C light-emitting sealed body
2 housing structure
3 first electrode
4 second electrode
5 first holder
6 second holder
7 housing
8 enclosure
8A first enclosing portion
8B second enclosing portion
20A laser beam incidence window (first window)
20B plasma light emission window (second window)
20C laser beam emission window (fourth window, third window)
20D laser beam passage window (third window)
21, 23, 25, 27 window member
31 distal end (first distal end)
41 distal end (second distal end)
70a, 80a wall
81 enclosed space
82 light passage opening (first opening)
82a open end
83 light passage opening (second opening)
83a open end
G gas
L1 laser beam (first light)
L2 plasma light (second light)
R plasma region.

1. A light-emitting sealed body comprising:
a housing structure housing a gas for generating plasma,
wherein the housing structure includes
a first window configured to cause first light for maintaining the plasma in a plasma region where the plasma is generated to be incident on the plasma region,
a second window configured to emit second light emitted from the plasma from the plasma region,
a third window facing the first window with the plasma region interposed therebetween and configured to emit the first light transmitted through the plasma from the plasma region, and
a wall having a light shielding property and defining at least a light passage region of the third window.

2. The light-emitting sealed body according to claim 1, wherein the third window also emits the second light emitted from the plasma region to the third window side.

3. The light-emitting sealed body according to claim 1,
wherein the housing structure includes
a housing having the first window and the second window, and
an enclosure having the third window and the wall and defining an enclosed space including the plasma region in the housing.

4. The light-emitting sealed body according to claim 3,
wherein the enclosure has a first opening corresponding to the first window and a second opening corresponding to the second window,
the first window is positioned on an opposite side to the enclosed space with respect to an open end of the first opening on the enclosed space side,
the second window is positioned on an opposite side to the enclosed space with respect to an open end of the second opening on the enclosed space side, and
at least one of the first opening and the second opening is narrowed with respect to the enclosed space.

5. The light-emitting sealed body according to claim 3, further comprising:
a first electrode having a first distal end facing the plasma region in the housing;
a second electrode having a second distal end facing the plasma region in the housing, the second distal end facing the first distal end with the plasma region interposed therebetween; and
an insulating first holder holding the first electrode and fixed to the housing,
wherein the enclosure is an insulating enclosure enclosing the plasma region, the first distal end, and the second distal end in the housing and having a first opening corresponding to the first window and a second opening corresponding to the second window, and
at least a part of the enclosure is provided to the first holder.

6. The light-emitting sealed body according to claim 5, further comprising:
an insulating second holder holding the second electrode and fixed to the housing,
wherein the enclosure has a first enclosing portion and a second enclosing portion,
the first enclosing portion is provided as the part to the first holder, and
the second enclosing portion is provided to the second holder.

7. The light-emitting sealed body according to claim 3,
wherein the housing further includes a fourth window facing the third window, and
the fourth window emits the first light transmitted through the third window to an outside of the housing.

8. The light-emitting sealed body according to claim 7,
wherein each of the first window, the second window, the third window, and the fourth window includes a window member, and
a distance between the window member of the third window and the plasma region is smaller than each of a distance between the window member of the first window and the plasma region, a distance between the window member of the second window and the plasma region, and a distance between the window member of the fourth window and the plasma region.

9. The light-emitting sealed body according to claim 8, wherein a thickness of the window member of the third window is smaller than a thickness of the window member of the fourth window.

10. The light-emitting sealed body according to claim 1,
wherein the housing structure includes a housing having the first window, the second window, the third window, and the wall, and
the housing defines an enclosed space including the plasma region.
